(19) United States
(12) Patent Application Publication
(10) Pub. No.: US 2005/0117840 A1
(43) Pub. Date: Jun. 2, 2005

(54) Otdr with concurrently applied stimulus signals

(76) Inventor: Josef Beller, Tubingen (DE)

Correspondence Address: PERMAN & GREEN, 425 POST ROAD, FAIRFIELD, CT, 06824, US

(21) Appl. No.: 10/500,595

(22) PCT Filed: Jan. 16, 2002
(86) PCT No.: PCT/EP02/00358

(51) Int. Cl. G02B 6/28

(52) U.S. Cl. 385/24

(57) ABSTRACT

The present invention relates to a method of determination of optical properties of an optical component, comprising the steps of: a: coupling a first optical signal into the optical component, b: detecting at least one first optical signal reflected and/or backscattered by the optical component, c: using the detected optical signal to evaluate the distance the first optical signal has traveled between sending and detecting, and d: concurrently performing steps a-c for at least a second optical signal.

### BACKGROUND OF THE INVENTION

The present invention relates to determination of optical properties of an optical component, e.g. an optical fibre, more particularly to optical time domain reflectometry measurements and to optical time domain reflectometers (OTDRs) to perform these measurements.

In an OTDR for measurement of reflected optical signals, an optical signal with a defined measuring wavelength is coupled into the component under test, e.g. an optical fibre under test, and the reflected optical signal to be measured is detected with an optical detector connected to a computer for using the reflected optical signal for quantitative analysis and preferably visual representation.

Such OTDRs are known in the prior art. They are widely used during the installation of optical fibres to check for proper deployment and fibre integrity. U.S. Pat. No. 6,141,089 shows an OTDR of the aforementioned art for measurements in optical networks with currently applied traffic signals, for example.

To achieve a complete test coverage of the component under test the necessary measurements have to be conducted at different wavelengths which are similar to the wavelengths of the traffic signals that currently or later are routed through the fibres. A system for determination of such a wavelength dependent information is disclosed in EP 0,872,721 B1, the disclosure of which is incorporated herein by reference. With such an OTDR the measurements at different wavelengths are executed sequentially, i.e. a first measurement is taken at wavelengths λ₁, then a second measurement is taken at wavelength λ₂, and so on.

Since the receiver of such an OTDR of the prior art, a part of which is depicted in FIG. 1, cannot distinguish between different wavelengths of an optical input signal, the laser diodes have to be triggered one at a time to prevent measurement signals of different wavelengths to hit the receiver simultaneously. Because every measurement at each wavelength has to be repeated about 10000 times (or even more often) the whole measurement process takes a lot of time.

JP-A-05 281087 (Fujikura) discloses an OTDR with different wavelengths for light loss causing search. The so-called four-wave mixing for mapping chromatic dispersion in optical fibers is known from EP-A-819926 (Lucent).

### SUMMARY OF THE INVENTION

Therefore, it is an object of the invention to provide improved determination of optical properties of an optical component.

The object is solved by the independent claims.

An advantage of the present invention is the possibility to execute OTDR measurements with a number of different wavelengths in parallel. This is important because it can be foreseen that in the new dense wavelength division multiplexing (DWDM) networks the number of different test wavelengths starts to become high. Thus, the sequential execution of the measurements as known from the prior art would cause the total test time to increase considerably. However, the present invention allows for a significant reduction in measurement time by conducting OTDR measurements with different test wavelengths all at the same time.

In a preferred embodiment of the invention the inventive method is performed with a number of laser diodes which are connected to a wavelength multiplexer. With the help of a wideband directional coupler the signal of the wavelength multiplexer is coupled into a fiber under test. Furthermore, there is a wavelength demultiplexer coupled to the wideband directional coupler to receive the reflected optical signals reflected from the fiber under test. Connected to the wavelength demultiplexer is a respective number of individual receivers so that a multiwavelength input signal to the wavelength demultiplexer can be separated by the wavelength demultiplexer and processed individually in a straightforward way by the respective receivers.

Further preferred embodiments process the receiver output signals further separately by a respective number of data acquisition units. Alternatively, the receiver output signals can be multiplexed to feed a common signal processing circuit.

Furthermore, in a preferred embodiment of the present invention it is possible to calibrate the demultiplexer before using it for the measurement to consider cross-talk between the different reflected optical signals. The calibration of the demultiplexing is done by repeating the following steps for a set of wavelengths to be used for the optical signals: demultiplexing optical calibration signals having defined calibration wavelengths to a number of N demultiplexing ports, detecting a leakage of the optical calibration signal into each port. This gives the leakage L_{pw} of a wavelength w into a port p for all wavelengths and ports 1, 2, . . . , N. Therefore, it is possible to determine a matrix representation of the leakage L which correlates a matrix of the actual measurement signals Sₐ with a matrix of the ideal measurement signals Sᵢ according to the following formula:
Sᵢ=L⁻¹×Sₐ.

In another preferred embodiment of the present invention there is provided coding an optical signal with an unique feature, and detecting the optical signal by detecting its unique feature. By this, it is possible to assign each detected signal to the original sent signal.

Other preferred embodiments are shown by the dependent claims.

It is clear that the invention can be partly embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIG. 1 shows a schematic illustration of a part of the above mentioned OTDR setup of the prior art;

FIG. 2 shows an embodiment of the present invention; and

FIG. 3 shows the cross-talk problem that can occur with imperfect isolation between different ports of a demultiplexer.

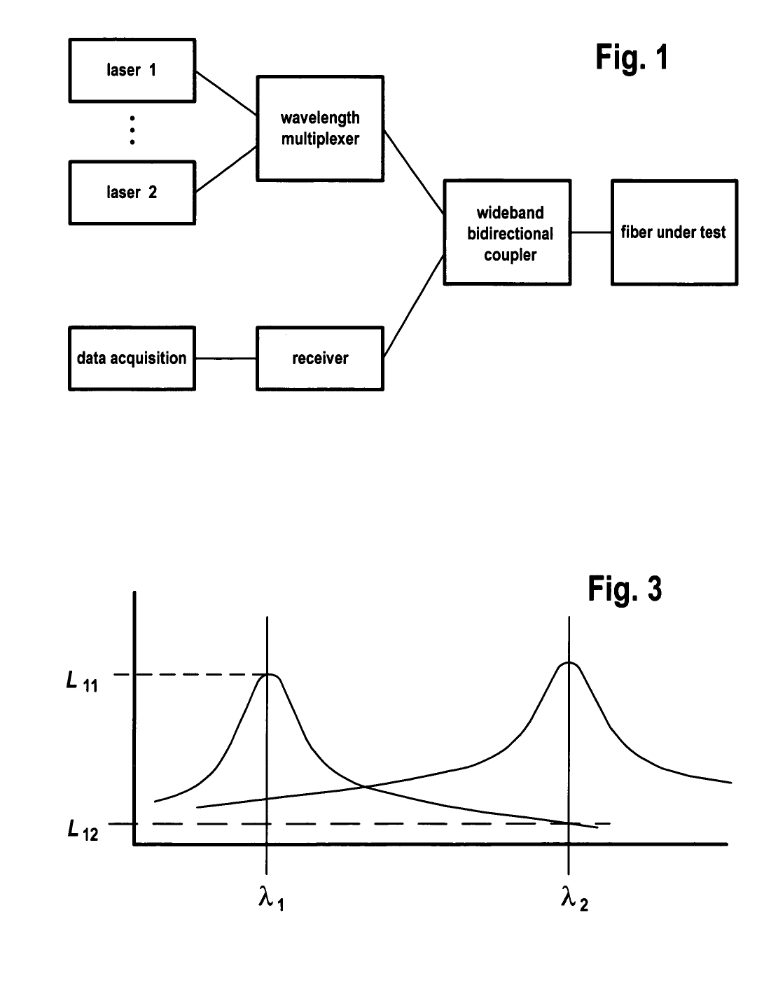

### DETAILED DESCRIPTION OF THE INVENTION

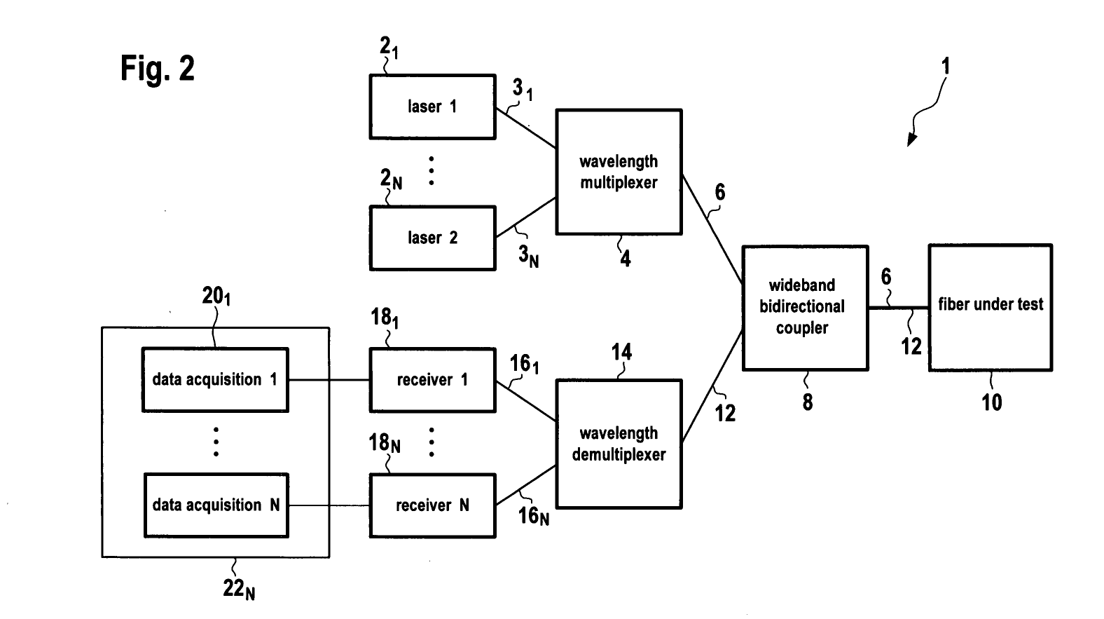

Referring now in greater detail to the drawings, FIG. 2 shows an embodiment 1 of an OTDR of the present invention. In embodiment 1 a number N of laser diodes 2₁ to 2_{N} emit optical signals 3₁ to 3_{N} to a wavelength multiplexer 4 connected with the laser diodes 2₁ to 2_{N}. The wavelength multiplexer 4 multiplexes the N optical signals 3₁ to 3_{N} and feeds a multiplexed signal 6 in a wideband directional coupler 8. The wideband directional coupler 8 couples the multiplexed signal 6 into a fiber under test 10. For further details of OTDRs refer to chapter 11 of “Dennis Derickson, Fiber Optic Test and Measurement, Prentice Hall PTR, Upper Saddle River, N.J. 07458, 1998”, the disclosure of which is incorporated herein be reference.

Reflected optical signals 12 reflected from the fiber under test 10 are coupled via the wideband directional coupler 8 into a wavelength demultiplexer 14. The wavelength demultiplexer 14 is demultiplexing the reflected optical signals 12 into demultiplexed signals 16₁ to 16_{N}. The demultiplexed signals 16₁ to 16_{N} are detected by N receivers 18₁ to 18_{N}. Each receiver 18₁ to 18_{N} of the N receivers 18₁ to 18_{N} is connected with a data acquisition module 20₁ to 20_{N} of a computer 22 to analyze and preferably show the acquired results on a (not shown) monitor. In the illustrated embodiment 1 of FIG. 2 the number N of measurement wavelengths can vary between 1 and any other reasonable natural number.

However, the demultiplexer 14 in this embodiment is an additional component in the test signal path, which inevitably affects the test results due to its non-ideal behavior. Therefore, the insertion-loss of the demultiplexer 14 should be minimized in order to not decrease the dynamic range of the OTDR measurement performed with the shown embodiment 1.

However, what is more important, is the possible limited wavelength isolation between the individual output ports of the wavelength demultiplexer 14.

FIG. 3 shows this cross-talk problem that can occur with imperfect isolation between the different ports of the wavelength demultiplexer 14. Small spurious signals from any port superimposed to any other output port and can lead to useless test results. On the left hand side of FIG. 3 there is shown a first detected reflected optical signal having a wavelength λ₁. On the right hand side of FIG. 3 there is shown a second detected reflected optical signal having a wavelength λ₂. As can be seen from FIG. 3 a part L₁₂ of the signal detected at wavelength λ₁ adds to the signal detected at wavelength λ₂ and a part of the signal detected at wavelength λ₂ adds to the signal detected at the wavelength λ₁.

The inventive method deals with this possible problem by determining the leakage L_{pw} of wavelength w into port p, for all wavelengths and ports 1, 2, . . . , N, and to consider this in a post processing step. To derive the necessary formulas a general relation between the actual measurement signal sₐ and the ideal measurement signal si is needed. For the actual signal sₐ₁ at port 1 the following equation holds:
sₐ₁=L₁₁×sᵢ₁+L₁₂sᵢ₂+L₁₃×sᵢ₃+ . . . +L_{1N}×s_{iN}

In a similar way the actual signals at the other ports can be given. A matrix representation is the preferred way to combine the complete set of equations:

$${S}_{a} = L \times {S}_{i} with$$

$${S}_{a} = ( \begin{matrix}{s}_{a1} \\ ⋮ \\ {s}_{aN}\end{matrix} ) {S}_{i} = ( \begin{matrix}{s}_{i1} \\ ⋮ \\ {s}_{iN}\end{matrix} ) and$$

$$L = ( \begin{matrix}{L}_{11} & ⋯ & ⋯ & {L}_{1 N} \\ ⋮ & ⋯ & ⋯ & ⋮ \\ ⋮ & ⋯ & ⋯ & ⋮ \\ {L}_{N1} & ⋯ & ⋯ & {L}_{NN}\end{matrix} )$$

Solving the matrix equation for the required set of signals Sᵢ yields readily
Sᵢ=L⁻¹×Sₐ
with L⁻¹ being the inverse of matrix L.

In a practical arrangement as in embodiment 1 of FIG. 2, the set of actual signals Sₐ depends on several factors like different laser output power of the laser diodes 2₁ to 2_{N}, fiber scatter factor of the optical fiber 10, and coupling ratio of the directional coupler 8. In addition, the leakage factors L_{pw} of the demultiplexer can be temperature dependent. Therefore, an automatic calibration step is proposed prior to a multi-wavelength measurement to determine the relation between Sᵢ and Sₐ. It can be implemented in a way, where fast single wavelength measurements were taken for each wavelength λ_{w}, and each acquired signal sₐ on port p (p=1 . . . N) is used to calculate the leakage factor L_{pw} with reference to Lₚₚ which is always set to 1. After N single wavelength measurements, which take only a fraction of a second, matrix L is known and matrix L⁻¹ can be calculated. During calibration, the optical component 10 is not connected to the coupler 8, instead a reflection of a then open connector of the coupler 8 is used for calibration purposes. Alternatively, a mirror can be connected to the open connector of coupler 8. After the calibration the multi-wavelength measurement can be conducted and the ideal signals sᵢ can be calculated.

1. A method of determination of optical properties of an optical component, comprising the steps of:
a: multiplexing a first optical signal with at least a second optical signal to a multiplexed optical signal,
b: coupling the multiplexed optical signal to the optical component,
c: demultiplexing optical signals reflected and/or backscattered by the optical component,
d: detecting each demultiplexed optical signal,
e: using the detected optical signals to evaluate the distance the first optical signal has traveled between sending and detecting.

2. The method of claim 1,
wherein each of the first and at least second optical signals has a different wavelength.

3. The method of any one of the claims 1, further comprising the steps of:
evaluating the distance each optical signal has traveled by:
measuring the time between coupling each optical signal into the optical component and detecting each optical signal.

4. The method of claim 1, further comprising the steps of:
f: performing steps a-e at least one more time, and
g: adding on the detected optical signals of each cycle of step f to enhance the signal strength of the detected optical signals.

5. The method of claim 1, further comprising the step of:
considering cross-talk between the optical signals when evaluating the distance the detected optical signals have traveled between coupling them into the optical component and detecting them.

6. The method of claim 5, further comprising the steps of:
considering cross-talk by:
calibrating the demultiplexing before performing steps a-e.

7. The method of claim 6, further comprising the steps of:
calibrating the demultiplexing by repeating the following steps for a set of wavelengths to be used for the optical signals:
demultiplexing optical calibration signals having defined calibration wavelengths to a number of N ports, N being a natural number, and
detecting a leakage of the optical calibration signal into at least another port.

8. The method of claim 1, further comprising the steps of:
coding each optical signal with an unique feature, and
detecting the optical signals by detecting its unique feature.

9. A method of determination of optical properties of an optical component, comprising the steps of:
coding an optical signal with an unique feature, and
detecting the optical signal by detecting its unique feature.

10. A software program or product; preferably stored on a data carrier, for executing the method of claim 9, when run on a data processing system such as a computer.

11. An apparatus for determination of optical properties of an optical component under test, comprising:
a multiplexer adapted for multiplexing a plurality of optical signals a coupler for coupling the multiplexed plurality of optical signals to the optical component,
a demultiplexer for demultiplexing optical signals reflected and/or backscattered by the optical component,
at least one detector for detecting at least one of the demultiplexed optical signals, and
an evaluating unit using the at least one detected optical signal to evaluate a distance the at least one detected optical signal has traveled between coupling the at least one optical signal in the optical component and detecting the at least one optical signal.

12. The apparatus of claim.11, further comprising:
a calibration unit for calibrating the demultiplexer by repeating the following steps for a set of wavelengths to be used for the optical signals: demultiplexing optical calibration signals having defined calibration wavelengths to a number of N ports, N being a natural number, and detecting a leakage of the optical calibration signal into at least another port.
